(19) United States
(12) Patent Application Publication
(10) Pub. No.: US 2023/0030087 A1
(43) Pub. Date: Feb. 2, 2023

(54) INFORMATION PROCESSING APPARATUS, INFORMATION PROCESSING METHOD, AND NON-TRANSITORY COMPUTER READABLE MEDIUM

(71) Applicant: FUJIFILM Business Innovation Corp., Tokyo (JP)

(72) Inventor: Atsushi ITO, Kanagawa (JP)

(73) Assignee: FUJIFILM Business Innovation Corp., Tokyo (JP)

(21) Appl. No.: 17/547,144

(22) Filed: Dec. 9, 2021

(30) Foreign Application Priority Data
Jul. 28, 2021 (JP) 2021-123741

(51) Int. Cl. G06F 40/103

(52) U.S. Cl. CPC G06F 40/103

(57) ABSTRACT

An information processing apparatus includes a processor configured to accept specification of at least one piece of document data and specification of a specific attribute of chart data and to present chart data that is contained in the at least one piece of document data and that has the specific attribute.

This application is based on and claims priority under 35 USC 119 from Japanese Patent Application No. 2021-123741 filed Jul. 28, 2021.

### BACKGROUND

### (i) Technical Field

The present disclosure relates to an information processing apparatus, an information processing method, and a non-transitory computer readable medium.

### (ii) Related Art

Japanese Unexamined Patent Application Publication No. 2008-52496 discloses an image display apparatus configured to divide imagery into image components, determine attributes of image components obtained by the division, select multiple image components based on the result of the division or based on the result of the division and the result of the determination of attributes, and present the selected image components in a predetermined display region.

Japanese Unexamined Patent Application Publication No. 2008-40753 discloses an image processing apparatus configured to divide document imagery into image components, accept a search key using a keyword, search each page of the document imagery, create a display screen on which to present one or more pieces of document imagery found in the keyword search, and select an image component obtained by the imagery division, the display screen presenting a thumbnail image representing the view of a page, text information containing the keyword used for the search, and the selected image component, which are arranged for each page.

### SUMMARY

It is difficult to efficiently search document data for chart data having a specified attribute while the document data is open.

Aspects of non-limiting embodiments of the present disclosure relate to enabling an efficient search of document data for chart data having a specified attribute compared with searching document data for chart data having a specified attribute while the document data is open.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to accept specification of at least one piece of document data and specification of a specific attribute of chart data and to present chart data that is contained in the at least one piece of document data and that has the specific attribute.

### BRIEF DESCRIPTION OF THE DRAWINGS

An exemplary embodiment of the present disclosure will be described in detail based on the following figures, wherein:

FIG. 1 depicts an example of an overall configuration of a document-imagery search system according to an exemplary embodiment of the present disclosure;

FIG. 2 is a diagram depicting an example of a hardware configuration of a document-imagery server according to the exemplary embodiment of the present disclosure;

FIG. 3 depicts a first example of a screen displayed by a client terminal according to the exemplary embodiment of the present disclosure;

FIG. 4 depicts an example of a narrowing-down screen displayed by the client terminal according to the exemplary embodiment of the present disclosure;

FIG. 5 depicts an example of a screen displayed by the client terminal after a narrowing-down operation according to the exemplary embodiment of the present disclosure;

FIG. 6 depicts a second example of a screen displayed by the client terminal according to the exemplary embodiment of the present disclosure;

FIG. 7 depicts an example of an arrangement screen displayed by the client terminal according to the exemplary embodiment of the present disclosure;

FIG. 8 depicts an example of a screen displayed by the client terminal after an arrangement operation according to the exemplary embodiment of the present disclosure;

FIG. 9 is a block diagram depicting an example of a functional configuration of the document-imagery server according to the exemplary embodiment of the present disclosure;

FIG. 10 is a flowchart depicting a first example operation of the document-imagery server to extract an image component according to the exemplary embodiment of the present disclosure;

FIG. 11 is a flowchart depicting a second example operation of the document-imagery server to extract an image component according to the exemplary embodiment of the present disclosure;

FIG. 12 is a flowchart depicting a third example operation of the document-imagery server to extract an image component according to the exemplary embodiment of the present disclosure;

FIG. 13 is a flowchart depicting an example operation of the document-imagery server to transmit to the client terminal display information for presenting image components in list form according to the exemplary embodiment of the present disclosure;

FIG. 14 is a flowchart depicting an operation of the document-imagery server to narrow down image components in list form according to the exemplary embodiment of the present disclosure;

FIG. 15 is a flowchart depicting an operation of the document-imagery server to arrange image components in list form according to the exemplary embodiment of the present disclosure; and

FIG. 16 is a flowchart depicting an operation of the document-imagery server to transmit document imagery to the client terminal according to the exemplary embodiment of the present disclosure.

### DETAILED DESCRIPTION

Hereinafter, an exemplary embodiment of the present disclosure will be described in detail with reference to the attached drawings.

### Outline of Present Exemplary Embodiment

According to the present exemplary embodiment, there is provided an information processing apparatus configured to accept specification of at least one piece of document data and specification of a specific attribute of chart data and to present chart data that is contained in the at least one piece of document data and that has the specific attribute.

The term “document data” refers to at least one document in an electronic form, and examples of document data include a document file created by using document-creation software and document imagery generated by imaging of a document file. The phrase “to open document data” indicates that document data is made viewable by using dedicated software corresponding to the document data. Document data may be at least one document file, document imagery, or a combination of the two, and the following description will be given with regard to document imagery as an example of document data. In this case, document imagery may be obtained by imaging of at least one document file at the time that the at least one document file is stored in a document-imagery server. A portion of a piece of document data may indicate any portion of a piece of document data.

A portion of a piece of document data in the following description indicates an image of a page of a piece of document data, that is, an image of a page of a piece of document imagery as an example.

The term “chart data” refers to at least one chart in an electronic form. Examples of chart data include data representing a graph, a block diagram, a flowchart, a map, and a table, which are created by using chart-creation software, and such chart data may be inserted into or pasted on a document file. Alternatively, chart data may be an image component that is obtained by imaging of data created by using chart-creation software and that is contained in document imagery. Chart data may be data itself created by using chart-creation software. Alternatively, chart data may be an image component, and an image component will be taken as an example of chart data in the following description. If a document file is adopted as document data, it is assumed that document imagery obtained by imaging of the document file is temporarily created when chart data is extracted from the document file. Accordingly, one or more image components obtained by imaging of chart data contained in the document file are also temporarily created.

An attribute of chart data indicates a property or a feature owned by each chart. Attributes of chart data are divided into two groups. An attribute in the first group is determined by performing any one of deep learning, classifying machine learning, and rule-based discrimination processing on document data, and an attribute in the second group is determined by performing operation such as image analysis and text analysis on chart data. In the following description, an attribute in the first group may be referred to as an attribute of the first kind, and an attribute in the second group may be referred to as an attribute of the second kind.

Examples of an attribute of the first kind include the type of chart. For example, a graph, a block diagram, a flowchart, a map, and a table are attributes of the first kind. Examples of an attribute of the first kind also include the type of graph. For example, a vertical bar graph, a horizontal bar graph, a line graph, a scatter diagram, a pie chart, a sunburst chart, a radar chart, and a combination thereof are attributes of the first kind. Further, examples of an attribute of the first kind also include appearances of a block diagram and a flowchart. For example, a vertical flow, a horizontal flow, and a mixture thereof are attributes of the first kind.

Examples of an attribute of the second kind include the appearance of a chart. Examples of the appearance of a chart include the colors used, whether the number of colors used is large or small, the magnitude of the density of picture elements (whether a chart is complex or simple), and the position and size of a chart in document data. Examples of an attribute of the second kind also include information regarding the axes and scale of a graph. Examples of such information include age, percentage, year, language type, country name, prefecture name, region name, company name, no label on the vertical axis, and no label on the horizontal axis. Examples of an attribute of the second kind also include the names of items in a legend of a graph. Examples of such an item include age, country name, prefecture name, company name, year, and sentences. Further, examples of an attribute of the second kind also include the name of an axis of a graph, the title of a chart (a character string placed above a chart), and a caption of a chart (a character string placed under a chart).

Although the information processing apparatus may be a stand-alone computer, description will be given below with regard to a document-imagery server in a document-imagery search system formed by the document-imagery server and a client terminal as an example.

### Overall Configuration of Document-Imagery Search System

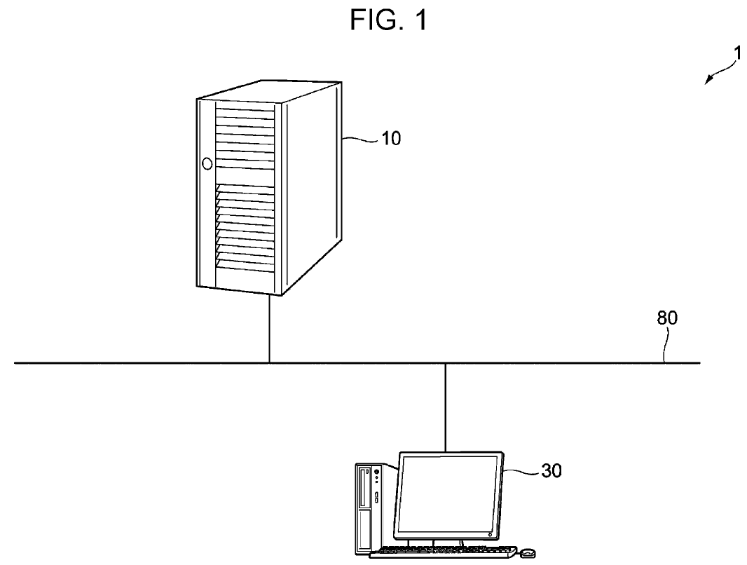

FIG. 1 depicts an example of an overall configuration of a document-imagery search system 1 according to the present exemplary embodiment. As depicted in FIG. 1, the document-imagery search system 1 is formed by a document-imagery server 10 and a client terminal 30, which are connected to a communication network 80. Only one document-imagery server 10 and one client terminal 30 are depicted in FIG. 1, but multiple document-imagery servers and multiple client terminals may be disposed.

The document-imagery server 10 is a server computer configured to manage document imagery and provide document imagery to the client terminal 30 in response to a search request from the client terminal 30. For example, a general-purpose personal computer (PC) may be used as the document-imagery server 10.

The client terminal 30 is a terminal apparatus used by a user who searches for document imagery managed by the document-imagery server 10. For example, a desktop PC, a notebook PC, or a portable information terminal may be used as the client terminal 30.

The communication network 80 is used for information communication between the document-imagery server 10 and the client terminal 30. For example, a local area network (LAN) or the Internet may be used as the communication network 80. Hardware Configuration of Document-Imagery Server

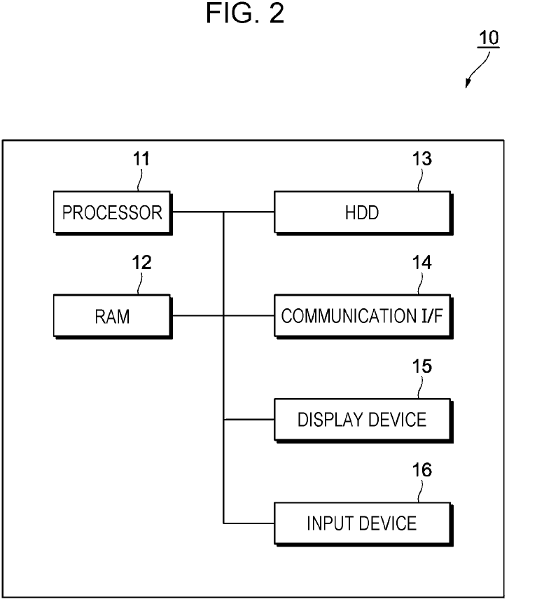

FIG. 2 is a diagram depicting an example of a hardware configuration of the document-imagery server 10 according to the present exemplary embodiment. As depicted in FIG. 2, the document-imagery server 10 includes a processor 11, a random-access memory (RAM) 12, a hard disk drive (HDD) 13, a communication interface (hereinafter, referred to as “communication I/F”) 14, a display device 15, and an input device 16.

The processor 11 is configured to execute various kinds of software such as the operating system (OS) and applications and to provide various functions described below.

The RAM 12 is a memory used as a working memory and the like for the processor 11. The HDD 13 is, for example, a magnetic disk device in which to store data such as is input from or output to the various kinds of software.

The communication I/F 14 is configured to transmit and receive various kinds of information to and from the client terminal 30 via the communication network 80.

The display device 15 is, for example, a display configured to present various kinds of information. The input device 16 is formed by, for example, a keyboard and a mouse, and used by the user to input information.

### Specific Example in Present Exemplary Embodiment

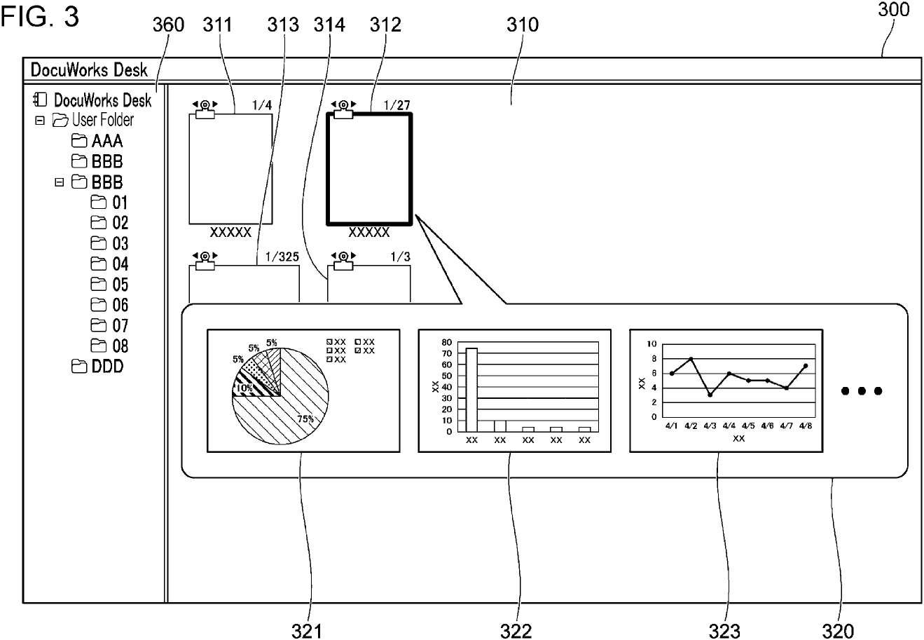

FIG. 3 depicts a first example of a screen 300 displayed by the client terminal 30 according to the present exemplary embodiment. The screen 300 in FIG. 3 includes a document display region 310 and a folder display region 360. Document icons 311 to 314 each representing a piece of document imagery are presented in the document display region 310. It is assumed that the user specifies the document icon 312, which is enclosed by a thick line, and requests presentation by specifying “graph” as the attribute in this situation. Then, the client terminal 30 presents in a search-result display region 320 one or more graphs contained in the piece of document imagery represented by the document icon 312. In this example, a pie chart 321, a vertical bar graph 322, a line graph 323, and other graphs are presented in the search-result display region 320.

It is assumed that too many graphs are presented in the search-result display region 320 in FIG. 3 and that it is difficult to find a target graph. To cope with such a situation, the client terminal 30 provides a user interface with which to narrow down the graphs.

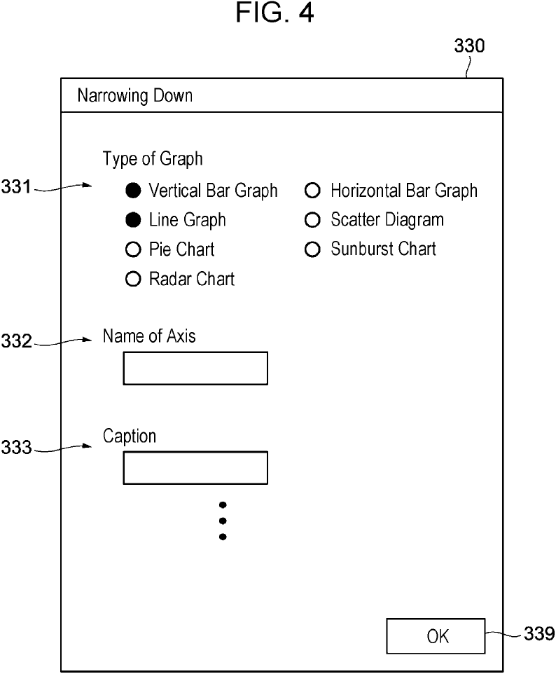

FIG. 4 depicts an example of a narrowing-down screen 330, which is a user interface with which to narrow down the graphs. The narrowing-down screen 330 includes a type-of-graph selection region 331 used to select the type of graph, a name-of-axis specification region 332 used to specify the name of an axis, a caption specification region 333 used to specify a caption, and an OK button 339. In this example, a vertical bar graph and a line graph are selected in the type-of-graph selection region 331. It is assumed that the user clicks on the OK button 339 in this situation.

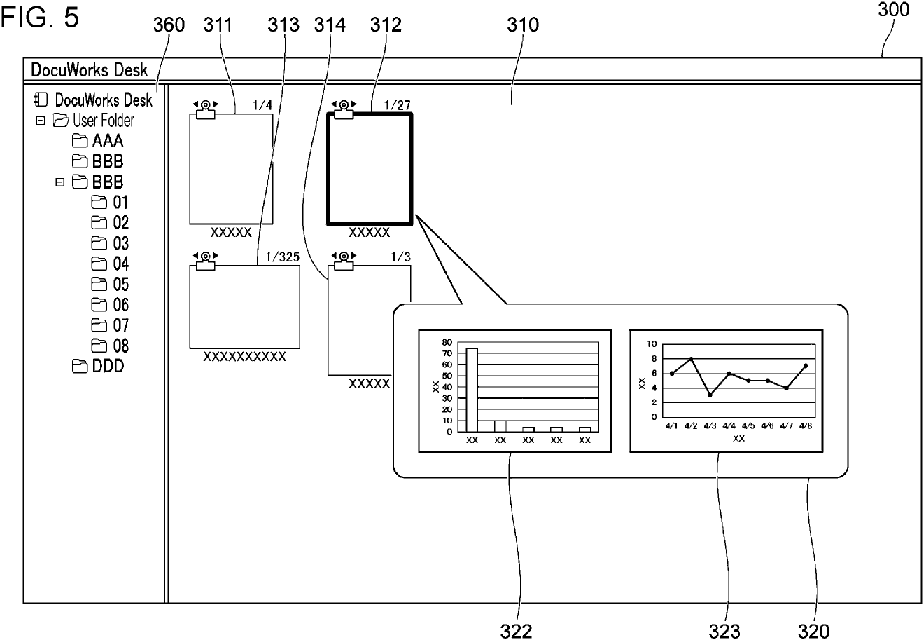

FIG. 5 depicts an example of the screen 300 displayed by the client terminal 30 when the user has performed such selection as is presented on the narrowing-down screen 330 in FIG. 4 and clicked on the OK button 339 after viewing the screen 300 in FIG. 3. The graphs presented in the search-result display region 320 in FIG. 5 are narrowed down to the vertical bar graph 322 and the line graph 323.

The user selects one of the vertical bar graph 322 and the line graph 323 in this situation. Then, the client terminal 30 presents an image of a page containing the selected graph, the image being selected from images of multiple pages contained in the piece of document imagery represented by the specified document icon 312.

These screen images are presented for illustration purposes only. For example, the narrowing-down screen 330 in FIG. 4 may contain a region in which to select or specify attributes other than the attributes described above.

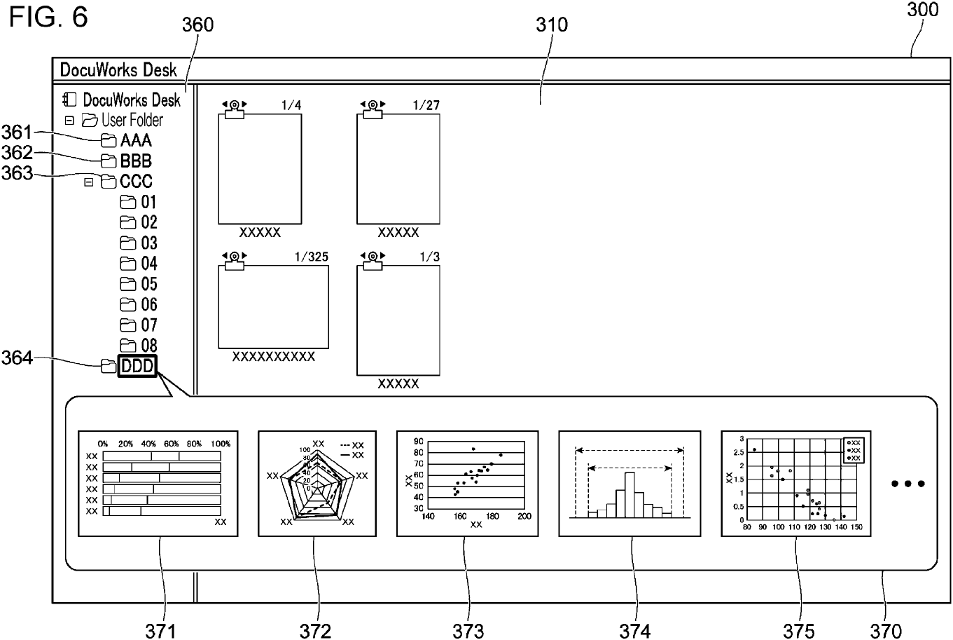

FIG. 6 depicts a second example of the screen 300 displayed by the client terminal 30 according to the present exemplary embodiment. The screen 300 in FIG. 6 also includes the document display region 310 and the folder display region 360. Folder icons 361 to 364 each representing a folder are presented in the folder display region 360. It is assumed that the user specifies the folder icon 364, which is enclosed by a thick line, and requests presentation by specifying “graph” as the attribute in this situation. Then, the client terminal 30 presents in a search-result display region 370 one or more graphs contained in the pieces of document imagery in the folder represented by the folder icon 364. In this example, a stacked bar graph 371, a radar chart 372, a scatter diagram 373, a vertical bar graph 374, a scatter diagram 375, and other graphs are presented in the search-result display region 370.

It is assumed that too many graphs are presented in the search-result display region 370 in FIG. 6 and that it is difficult to find a target graph. To cope with such a situation, the client terminal 30 provides a user interface with which to arrange the graphs.

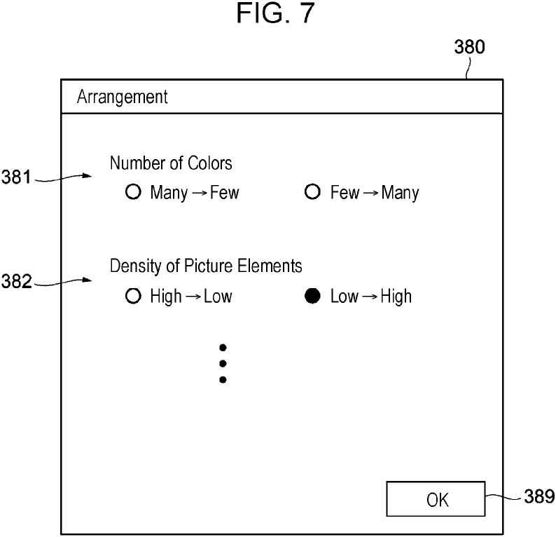

FIG. 7 depicts an example of an arrangement screen 380, which is a user interface with which to arrange the graphs. Two kinds of screens are possible as the arrangement screen 380. On a screen of a first kind, instructions are provided to present graphs in different regions in accordance with the attribute of a graph, and on a screen of a second kind, instructions are provided to present graphs arranged in an order in accordance with the attribute of a graph. A screen of the second kind will be described herein. Specifically, the arrangement screen 380 includes an order-selection region for the number of colors 381, an order-selection region for the density of picture elements 382, and an OK button 389. The order-selection region for the number of colors 381 is used to select the order in which the graphs are arranged in accordance with the number of colors, and the order-selection region for the density of picture elements 382 is used to select the order in which the graphs are arranged in accordance with the density of picture elements. In this example, the increasing order of the density of picture elements is selected in the order-selection region for the density of picture elements 382.

It is assumed that the user clicks on the OK button 389 in this situation.

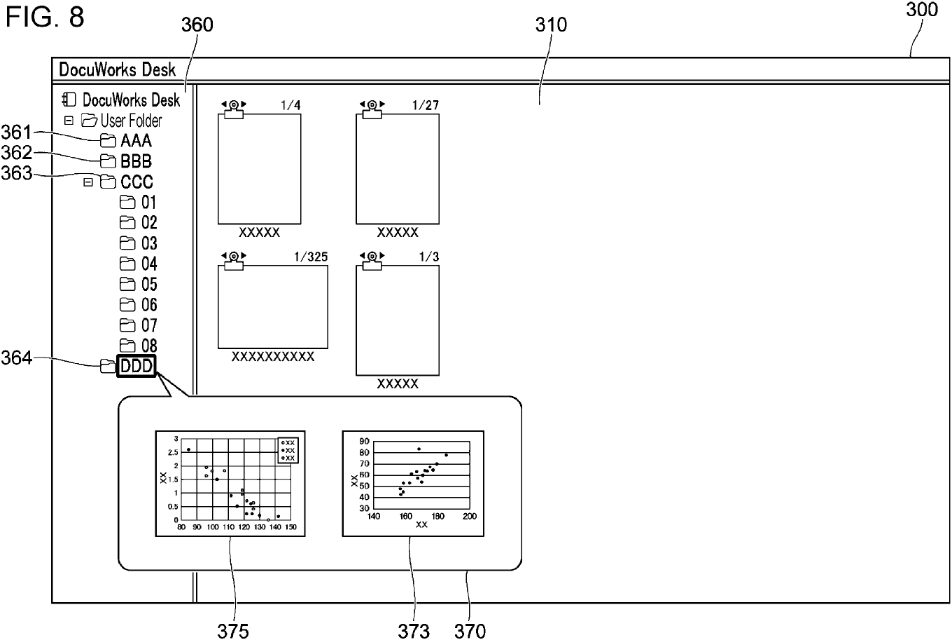

FIG. 8 depicts an example of the screen 300 displayed by the client terminal 30 when the user has performed such selection as is depicted on the arrangement screen 380 in FIG. 7 and clicked on the OK button 389. The user performs the selection after viewing the screen 300 in FIG. 6 and narrowing down the charts to scatter diagrams on the narrowing-down screen 330 in FIG. 4. In FIG. 8, the graphs presented in the search-result display region 370 have been narrowed down to the scatter diagrams 373 and 375, and the scatter diagram 375, which has a lower density of picture elements, and the scatter diagram 373, which has a higher density of picture elements, are arranged in the increasing order of the density of picture elements.

The user selects one of the scatter diagrams 373 and 375 in this situation. Then, the client terminal 30 presents a piece of document imagery containing the selected scatter diagram, the piece of document imagery being selected from the pieces of document imagery in the folder represented by the specified folder icon 364.

These screen images are presented for illustration purposes only. For example, the arrangement screen 380 in FIG. 7 may contain a region in which to select the order in which graphs are arranged in accordance with one of the attributes other than the attributes described above. Functional Configuration of Document-Imagery Server

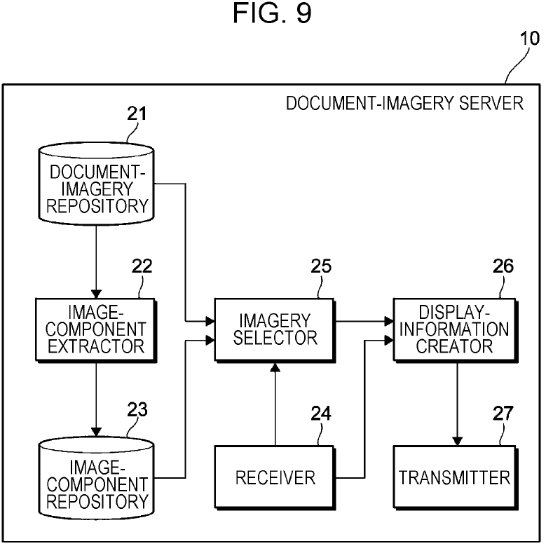

FIG. 9 is a block diagram depicting an example of a functional configuration of the document-imagery server 10 according to the present exemplary embodiment. As depicted in FIG. 9, the document-imagery server 10 includes a document-imagery repository 21, an image-component extractor 22, an image-component repository 23, a receiver 24, an imagery selector 25, a display-information creator 26, and a transmitter 27.

The document-imagery repository 21 stores document imagery. If document imagery only is expected to be specified by using the client terminal 30, the document-imagery repository 21 may store individual pieces of document imagery irrespective of a folder. If a folder is also expected to be specified by using the client terminal 30, the document-imagery repository 21 may store pieces of document imagery in corresponding folders.

The image-component extractor 22 extracts an image component and an attribute of the image component from document imagery stored in the document-imagery repository 21. The image component corresponds to a chart. Specifically, the image-component extractor 22 performs any one of deep learning, classifying machine learning, and rule-based discrimination processing on document imagery and extracts an image component and its attribute of the first kind. A way to extract an image component and its attribute of the first kind will be described in detail below. The image-component extractor 22 also performs analysis such as image analysis and text analysis on an image component in accordance with the kind of chart and extracts an attribute of the second kind of the image component. Further, the image-component extractor 22 acquires from the document imagery stored in the document-imagery repository 21 information used to link to a piece of document imagery.

The image-component repository 23 stores the image component extracted by the image-component extractor 22 in association with the attributes (of the first kind and the second kind) extracted by the image-component extractor 22. The image-component repository 23 also stores the information used to link to a piece of document imagery, the information being acquired by the image-component extractor 22 for the image component.

After the user specifies a piece of document imagery or a folder and specifies an attribute of a chart by using the client terminal 30, the receiver 24 receives specification of the piece of document imagery or the folder and specification of the attribute of a chart from the client terminal 30. The specification of a piece of document imagery or a folder can be regarded as specification of a search target and thus is referred to as “target specification”. The specification of an attribute of a chart is simply referred to as “attribute specification”. This processing is performed by the receiver 24 in the present exemplary embodiment as an example of accepting specification of at least one piece of document data and specification of a specific attribute of chart data.

In addition, after the user selects an attribute on the narrowing-down screen displayed by the client terminal 30, the receiver 24 receives from the client terminal 30 narrowing-down instructions to narrow down image components based on the attribute. This processing is performed by the receiver 24 in the present exemplary embodiment as an example of accepting specification of an attribute out of at least one attribute different from the specific attribute, the attribute being different from the specific attribute.

In addition, after the user specifies an attribute and a way of arrangement on the arrangement screen displayed by the client terminal 30, the receiver 24 receives from the client terminal 30 arrangement instructions to arrange image components in accordance with the way of arrangement with respect to the attribute. Specifically, the receiver 24 receives arrangement instructions to arrange the image components in different regions in accordance with the attribute or arrangement instructions to arrange the image components in the order in accordance with the attribute.

Further, after the user selects an image component and requests a search for document imagery by using the client terminal 30, the receiver 24 receives from the client terminal 30 a search request specifying the image component. This processing is performed by the receiver 24 in the present exemplary embodiment as an example of accepting specification of a specific piece of chart data out of at least one piece of chart data having an attribute different from the specific attribute and an example of accepting specification of a specific piece of chart data out of multiple pieces of chart data.

After the receiver 24 receives target specification and attribute specification, the imagery selector 25 selects in the image-component repository 23 an image component that is contained in a piece of document imagery specified by the target specification or contained in a piece of document imagery in a folder specified by the target specification and that has an attribute specified by the attribute specification. This processing is performed by the imagery selector 25 in the present exemplary embodiment as an example of identifying a specific attribute and chart data that have been extracted in advance from at least one piece of document data.

Further, when the user performs a narrowing-down operation by using the client terminal 30, the imagery selector 25 acquires from the image-component repository 23 attributes associated with image components to be narrowed down. This processing is performed by the imagery selector 25 in the present exemplary embodiment as an example of identifying at least one attribute that has been extracted in advance from at least one piece of document data.

Further, when the user performs an arrangement operation by using the client terminal 30, the imagery selector 25 acquires from the image-component repository 23 attributes associated with image components to be arranged.

Further, after the receiver 24 receives a search request specifying an image component, the imagery selector 25 selects in the document-imagery repository 21 a piece of document imagery containing the image component or an image of a page containing the image component. Specifically, in the case where the user specifies a piece of document imagery by using the client terminal 30, the imagery selector 25 selects in the document-imagery repository 21 an image of a page containing the image component in the piece of document imagery. Further, in the case where the user specifies a folder by using the client terminal 30, the imagery selector 25 selects in the document-imagery repository 21 a piece of document imagery containing the image component.

In the case where the receiver 24 receives target specification and attribute specification, the display-information creator 26 creates display information for presenting an image component selected by the imagery selector 25. This processing is performed by the display-information creator 26 in the present exemplary embodiment as an example of presenting chart data that is contained in at least one piece of document data and that has a specific attribute.

Further, in the case where the user performs a narrowing-down operation by using the client terminal 30, the display-information creator 26 creates display information for presenting a narrowing-down screen including the attributes acquired by the imagery selector 25. Thereafter, after the receiver 24 receives narrowing-down instructions, the display-information creator 26 narrows down based on the narrowing-down instructions the image components that have been selected by the imagery selector 25 and creates display information for presenting image components obtained by the narrowing-down operation. When chart data is formed by multiple pieces of chart data in the present exemplary embodiment, this processing is performed by the display-information creator 26 as an example of further presenting at least one attribute of the multiple pieces of chart data, the at least one attribute being different from the specific attribute. Further, this processing is performed by the display-information creator 26 in the present exemplary embodiment as an example of presenting at least one piece of chart data having an attribute different from the specific attribute, the at least one piece of chart data being obtained by narrowing down multiple pieces of chart data.

Further, in the case where the user performs an arrangement operation by using the client terminal 30, the display-information creator 26 creates display information for presenting an arrangement screen including the attributes acquired by the imagery selector 25. Thereafter, after the receiver 24 receives arrangement instructions, the display-information creator 26 arranges based on the arrangement instructions the image components that have been selected by the imagery selector 25 and creates display information for presenting image components after the arrangement operation. Specifically, the display-information creator 26 creates display information for presenting the image components in different regions in accordance with the attribute or display information for presenting the image components arranged in the order in accordance with the attribute. Alternatively, the display-information creator 26 may more broadly be defined as creating display information for presenting the image components in accordance with the attribute. When chart data is formed by multiple pieces of chart data in the present exemplary embodiment, this processing is performed by the display-information creator 26 as an example of presenting the multiple pieces of chart data based on an attribute of the multiple pieces of chart data, the attribute being different from the specific attribute. Further, this processing is performed by the display-information creator 26 in the present exemplary embodiment as an example of presenting the multiple pieces of chart data in different regions in accordance with an attribute different from the specific attribute of the multiple pieces of chart data or presenting the multiple pieces of chart data arranged in an order in accordance with an attribute different from the specific attribute of the multiple pieces of chart data.

Further, in the case where the receiver 24 receives a search request specifying an image component, the display-information creator 26 creates display information for presenting a piece of document imagery selected by the imagery selector 25 or an image of a page of a piece of document imagery. Specifically, in the case where the user first specifies a piece of document imagery, the display-information creator 26 creates display information for presenting an image of a page of the piece of document imagery. In the case where the user first specifies a folder, the display-information creator 26 creates display information for presenting a piece of document imagery.

This processing is performed by the display-information creator 26 in the present exemplary embodiment as an example of presenting a piece of document data containing a specific piece of chart data or a portion of a piece of document data containing a specific piece of chart data out of at least one piece of document data.

The transmitter 27 transmits the display information created by the display-information creator 26 to the client terminal 30.

### Operation of Document-Imagery Server

First, description will be given with regard to an operation of the image-component extractor 22 of the document-imagery server 10 to extract an image component in the present exemplary embodiment. Document imagery from which an image component is extracted is referred to as “target document imagery” in this operation.

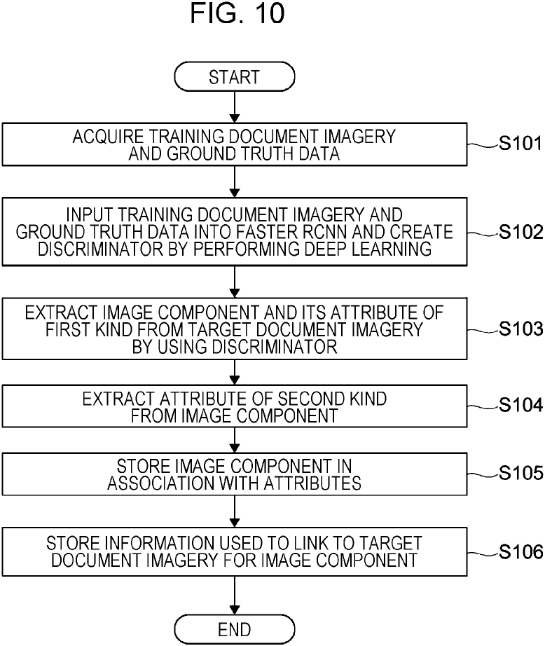

FIG. 10 is a flowchart depicting a first example operation of the image-component extractor 22 of the document-imagery server 10 to extract an image component. The first example operation represents an operation in which to use deep learning.

As depicted in FIG. 10, the image-component extractor 22 acquires training document imagery and ground truth data (step S101). Ground truth data provides true data created by an operator to train a discriminator with respect to the training document imagery and describes positions and attributes of one or more image components contained in the training document imagery.

Then, the image-component extractor 22 inputs the training document imagery and the ground truth data, which are acquired in step S101, into, for example, the Faster Region Based Convolutional Neural Networks (RCNN) and creates a discriminator by performing deep learning (step S102) .

Next, the image-component extractor 22 extracts an image component and its attribute of the first kind from target document imagery by using the discriminator, which is created in step S102 (step S103) .

Subsequently, the image-component extractor 22 extracts an attribute of the second kind from the image component extracted in step S103 (step S104). At this time, the image-component extractor 22 may determine a region from which the attribute of the second kind is to be extracted in the image component in accordance with the attribute of the first kind extracted in step S103.

Thereafter, the image-component extractor 22 stores the image component extracted in step S103 in the image-component repository 23 in association with the attribute of the first kind extracted in step S103 and the attribute of the second kind extracted in step S104 (step S105). For example, the image-component extractor 22 may store the image component extracted in step S103 in the image-component repository 23 for each attribute of the first kind extracted in step S103 and for each attribute of the second kind extracted in step S104.

Finally, the image-component extractor 22 stores information used to link to the target document imagery for the image component, which is stored in the image-component repository 23 in step S105 (step S106). Information regarding a region in which the target document imagery is stored in the document-imagery repository 21 may be used as the information used to link to the target document imagery.

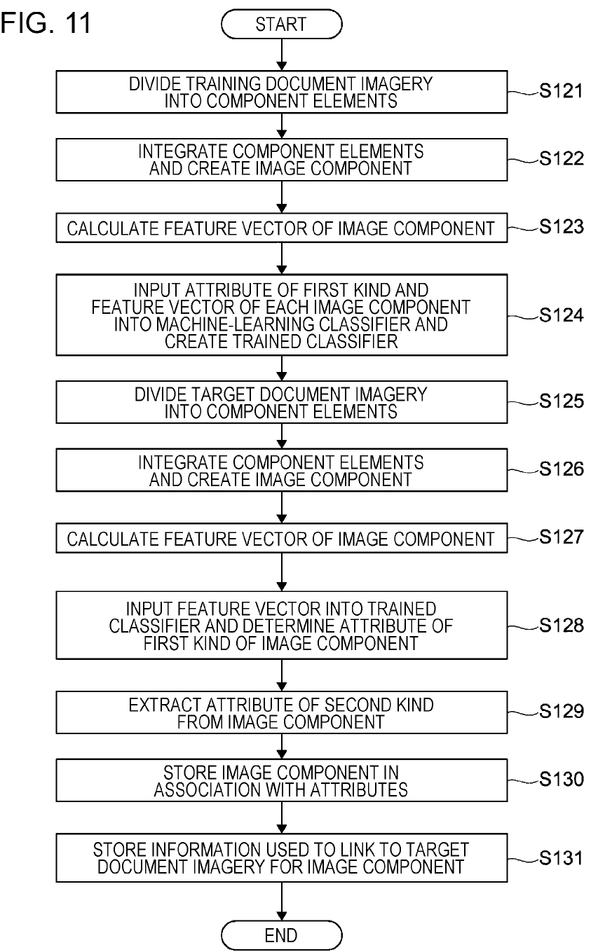

FIG. 11 is a flowchart depicting a second example operation of the image-component extractor 22 of the document-imagery server 10 to extract an image component. The second example operation represents an operation in which to use classifying machine learning.

As depicted in FIG. 11, the image-component extractor 22 first divides training document imagery into component elements (step S121). A component element is an element formed by picture elements that are interconnected with each other to form, for example, training document imagery.

Then, the image-component extractor 22 integrates multiple component elements obtained in step S121 and creates an image component (step S122). Specifically, the image-component extractor 22 integrates multiple component elements based on parameters such as the distances between the component elements, the arrangement of the multiple component elements, and a provisional attribute of each component element. For example, in the case of a bar graph having no axes, the image-component extractor 22 obtains a bar graph by integrating multiple component elements that each have a provisional attribute of rectangle and that are uniformly arranged at equal distances between the component elements. The image-component extractor 22 sometimes does not integrate multiple component elements. A component element becomes an image component without a change in such a case.

Next, the image-component extractor 22 calculates a feature vector for each image component created in step S122 (step S123). Examples of a feature included in a feature vector include the density of picture elements, the color ratio, the variance in color density, the number of edges, the edge variance, the density of lines, and the ratio of orthogonal lines.

Subsequently, the image-component extractor 22 inputs an attribute of each image component created in step S122 and the feature vector calculated in step S123 into a machine-learning classifier and creates a trained classifier (step S124). The attribute of each image component to be used may be determined by the operator who trains the classifier.

On the other hand, the image-component extractor 22 divides target document imagery into component elements (step S125). A component element is an element formed by picture elements that are interconnected with each other to form, for example, target document imagery.

Then, the image-component extractor 22 integrates multiple component elements obtained in step S125 and creates an image component (step S126). Specifically, the image-component extractor 22 integrates the multiple component elements based on the distances between the component elements, the arrangement of the multiple component elements, a provisional attribute of each component element, and other parameters. For example, the image-component extractor 22 integrates multiple component elements and obtains a bar graph based on the fact that multiple component elements having a provisional attribute being a rectangle are uniformly arranged at equal distances between the component elements in a bar graph having no axes. The image-component extractor 22 sometimes does not integrate multiple component elements. A component element becomes an image component without a change in such a case.

Next, the image-component extractor 22 calculates a feature vector for each image component created in step S126 (step S127). Examples of a feature included in a feature vector include the density of picture elements, the color ratio, the variance in color density, the number of edges, the edge variance, the density of lines, and the ratio of orthogonal lines.

Subsequently, the image-component extractor 22 inputs the feature vector calculated in step S127 into the trained classifier created in step S124 and determines an attribute of the first kind of the image component created in step S126. (step S128) .

Next, the image-component extractor 22 extracts an attribute of the second kind from the image component created in step S126 (step S129). At this time, the image-component extractor 22 may determine a region from which the attribute of the second kind is to be extracted in the image component in accordance with the attribute of the first kind determined in step S128.

Thereafter, the image-component extractor 22 stores the image component created in step S126 in the image-component repository 23 in association with the attribute of the first kind determined in step S128 and the attribute of the second kind extracted in step S129 (step S130). For example, the image-component extractor 22 may store the image component created in step S126 in the image-component repository 23 for each attribute of the first kind determined in step S128 and for each attribute of the second kind extracted in step S129.

Finally, the image-component extractor 22 stores information used to link to the target document imagery for the image component, which is stored in the image-component repository 23 in step S130 (step S131). Information regarding a region in which the target document imagery is stored in the document-imagery repository 21 may be used as the information used to link to the target document imagery.

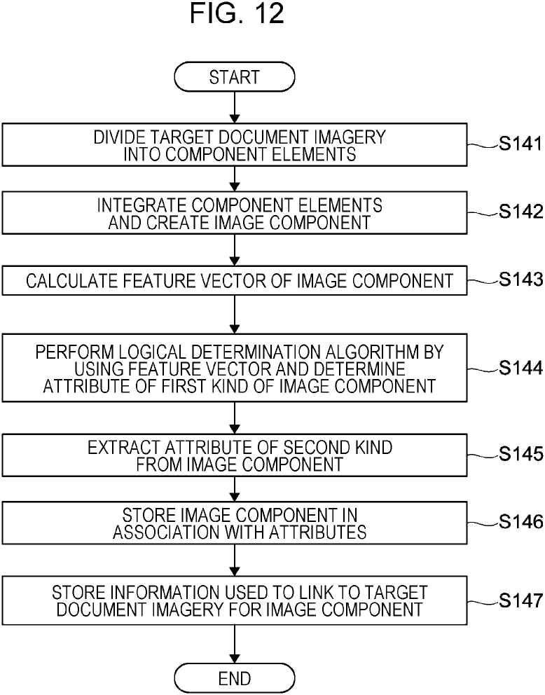

FIG. 12 is a flowchart depicting a third example operation of the image-component extractor 22 of the document-imagery server 10 to extract an image component. The third example operation represents an operation in which to use rule-based discrimination processing.

As depicted in FIG. 12, the image-component extractor 22 first divides target document imagery into component elements (step S141). A component element is an element formed by picture elements that are interconnected with each other to form, for example, target document imagery.

Then, the image-component extractor 22 integrates multiple component elements obtained in step S141 and creates an image component (step S142). Specifically, the image-component extractor 22 integrates the multiple component elements based on the distances between the component elements, the arrangement of the multiple component elements, a provisional attribute of each component element, and other parameters. For example, the image-component extractor 22 integrates multiple component elements and obtains a bar graph based on the fact that multiple component elements having a provisional attribute being a rectangle are uniformly arranged at equal distances between the component elements in a bar graph having no axes. The image-component extractor 22 sometimes does not integrate multiple component elements. A component element becomes an image component without a change in such a case.

Next, the image-component extractor 22 calculates a feature vector for each image component created in step S142 (step S143). Examples of a feature included in a feature vector include the density of picture elements, the color ratio, the variance in color density, the number of edges, the edge variance, the density of lines, and the ratio of orthogonal lines.

Subsequently, the image-component extractor 22 performs a logical determination algorithm by using the feature vector calculated in step S143 and determines an attribute of the first kind of the image component (step S144). The logical determination algorithm is an algorithm created in advance by the operator who determines an attribute of the image component.

Subsequently, the image-component extractor 22 extracts an attribute of the second kind from the image component created in step S142 (step S145). At this time, the image-component extractor 22 may determine a region from which the attribute of the second kind is to be extracted in the image component in accordance with the attribute of the first kind determined in step S144.

Thereafter, the image-component extractor 22 stores the image component created in step S142 in the image-component repository 23 in association with the attribute of the first kind determined in step S144 and the attribute of the second kind extracted in step S145 (step S146). For example, the image-component extractor 22 may store the image component created in step S142 in the image-component repository 23 for each attribute of the first kind determined in step S144 and for each attribute of the second kind extracted in step S145.

Finally, the image-component extractor 22 stores information used to link to the target document imagery for the image component, which is stored in the image-component repository 23 in step S146 (step S147). Information regarding a region in which the target document imagery is stored in the document-imagery repository 21 may be used as the information used to link to the target document imagery.

Next, description will be given with regard to an operation of the document-imagery server 10 to transmit an image component and related information to the client terminal 30 in the present exemplary embodiment.

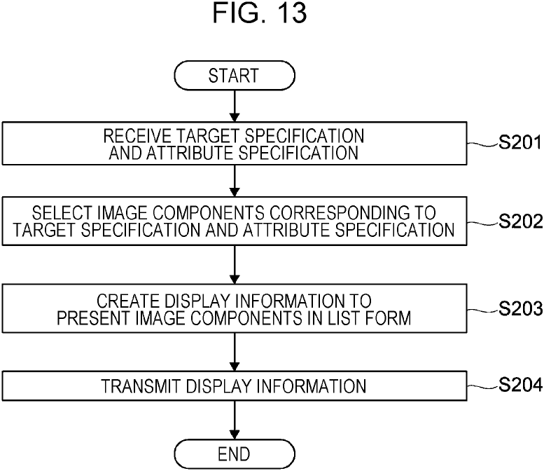

FIG. 13 is a flowchart depicting an example operation of the document-imagery server 10 to transmit to the client terminal 30 display information for presenting image components in list form.

As depicted in FIG. 13, the receiver 24 in the document-imagery server 10 receives target specification and attribute specification from the client terminal 30 (step S201). Target specification indicates specification provided by the user with regard to a piece of document imagery or a folder, as described above. Attribute specification indicates specification provided by the user with regard to an attribute of a chart, as described above.

Next, the imagery selector 25 selects one or more image components that correspond to the target specification and the attribute specification, which are received in step S201, from the image components stored in the image-component repository 23 (step S202). Specifically, the imagery selector 25 selects one or more image components that are contained in the piece of document imagery specified by the target specification or contained in document imagery in the folder specified by the target specification and that have the attribute specified by the attribute specification. The one or more image components are selected from the image components stored in the image-component repository 23. At this time, the imagery selector 25 may identify an image component associated with the information used to link to a piece of document imagery in the image-component repository 23 as an image component contained in the piece of document imagery. Further, the imagery selector 25 may identify an image component associated with an attribute in the image-component repository 23 as an image component having the attribute.

Next, the display-information creator 26 creates display information for presenting image components selected in step S202 in list form (step S203). For example, the display-information creator 26 creates display information for presenting the search-result display region 320 in FIG. 3 or the search-result display region 370 in FIG. 6.

Thereafter, the transmitter 27 transmits the display information created in step S203 to the client terminal 30 (step S204). In this way, for example, the search-result display region 320 in FIG. 3 or the search-result display region 370 in FIG. 6, which contains image components selected in step S202 in list form, is presented by the client terminal 30.

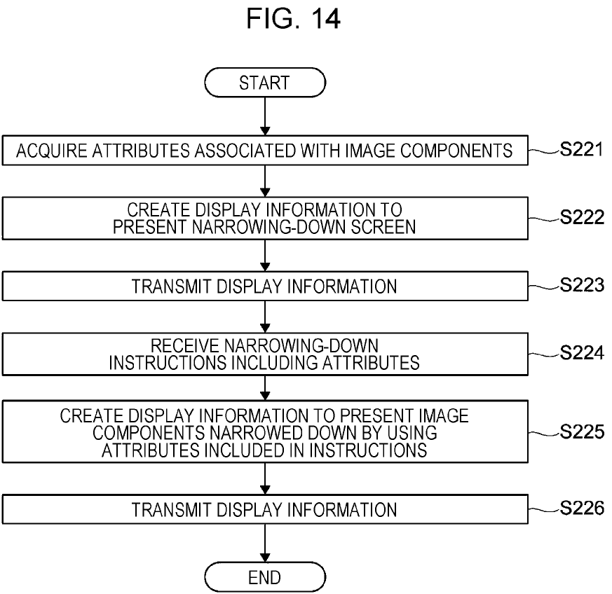

FIG. 14 is a flowchart depicting an operation of the document-imagery server 10 to narrow down a list of image components. The document-imagery server 10 performs this operation after the user inputs instructions to narrow down the list of image components by using the client terminal 30.

As depicted in FIG. 14, the imagery selector 25 in the document-imagery server 10 first acquires attributes associated with the image components presented by the client terminal 30, the attributes being associated with the image components in the image-component repository 23 (step S221) .

Next, the display-information creator 26 creates display information for presenting the narrowing-down screen 330 including the attributes acquired in step S221 (step S222) .

Subsequently, the transmitter 27 transmits the display information created in step S222 to the client terminal 30 (step S223). In this way, the client terminal 30 presents, for example, the narrowing-down screen 330 in FIG. 4.

It is assumed that the user selects or specifies one or more attributes on the narrowing-down screen 330 and provides narrowing-down instructions to narrow down image components in this way. Then, the receiver 24 in the document-imagery server 10 receives the narrowing-down instructions including one or more attributes from the client terminal 30 (step S224).

Next, the display-information creator 26 creates display information for presenting one or more image components obtained by a narrowing-down operation on the image components selected in step S202 in FIG. 13 (step S225). The image components are narrowed down by using the one or more attributes included in the narrowing-down instructions, which are received in step S224. Specifically, the display-information creator 26 replaces the display information, which is created in step S203 in FIG. 13 and retained, with display information for presenting the one or more image components obtained by the narrowing-down operation by using the one or more attributes included in the narrowing-down instructions.

Thereafter, the transmitter 27 transmits the display information created in step S225 to the client terminal 30 (step S226). In this way, for example, the search-result display region 320 in FIG. 5, which includes the one or more image components obtained by the narrowing-down operation in step S225, is presented by the client terminal 30.

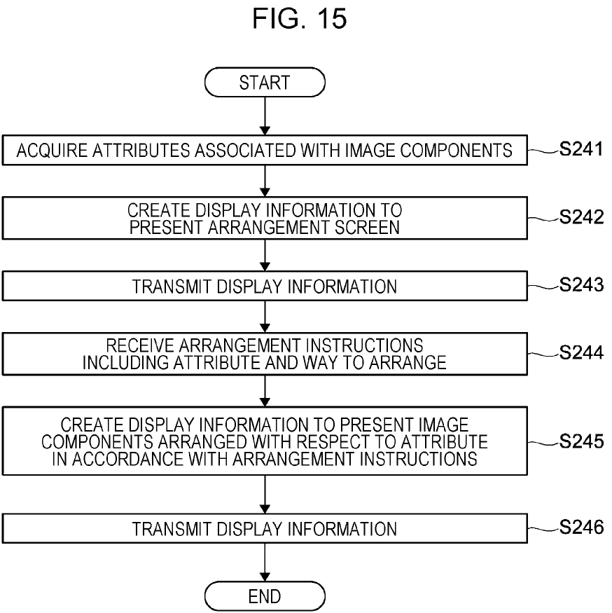

FIG. 15 is a flowchart depicting an operation of the document-imagery server 10 to arrange image components in list form. The document-imagery server 10 performs this operation after the user inputs instructions to arrange the image components in list form by using the client terminal 30.

As depicted in FIG. 15, the imagery selector 25 in the document-imagery server 10 first acquires attributes associated with the image components presented by the client terminal 30, the attributes being associated with the image components in the image-component repository 23 (step S241) .

Next, the display-information creator 26 creates display information for presenting the arrangement screen 380 including the attributes acquired in step S241 (step S242) .

Subsequently, the transmitter 27 transmits the display information created in step S242 to the client terminal 30 (step S243). In this way, the client terminal 30 presents, for example, the arrangement screen 380 in FIG. 7.

It is assumed that the user selects or specifies a way to perform arrangement with respect to an attribute on the arrangement screen 380 and provides arrangement instructions to arrange image components in this way. Examples of a way to perform arrangement include a way to arrange image components in different regions in accordance with an attribute and a way to arrange image components in the order in accordance with an attribute. Then, the receiver 24 in the document-imagery server 10 receives arrangement instructions including an attribute and a way to perform arrangement from the client terminal 30 (step S244).

Next, the display-information creator 26 creates display information for presenting the one or more image components selected in step S202 in FIG. 13 (step S245). The one or more image components, which are presented, are arranged in the way included in the arrangement instructions received in step S244 with respect to the attribute included in the arrangement instructions received in step S244. Specifically, the display-information creator 26 replaces the display information, which is created in step S203 in FIG. 13 and retained, with display information for presenting image components arranged in the way included in the arrangement instructions. The image components are arranged with respect to the attribute included in the arrangement instructions.

Thereafter, the transmitter 27 transmits the display information created in step S245 to the client terminal 30 (step S246). In this way, for example, the search-result display region 370 in FIG. 8, which includes the image components arranged in step S245, is presented by the client terminal 30.

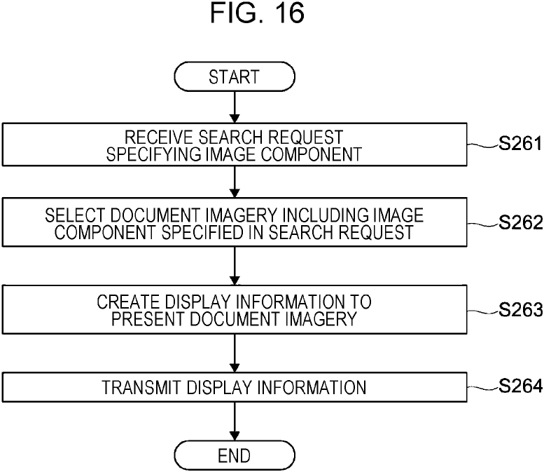

FIG. 16 is a flowchart depicting an operation of the document-imagery server 10 to transmit document imagery to the client terminal 30.

It is assumed that the user first sends a search request for document imagery, for example, by selecting an image component on the search-result display region 320 in FIG. 5 or in the search-result display region 370 in FIG. 8. Then, the receiver 24 in the document-imagery server 10 receives the search request specifying the image component from the client terminal 30 (step S261).

Next, the imagery selector 25 selects a piece of document imagery that includes the image component, which is specified in the search request received in step S261 (step S262). The piece of document imagery is selected from document imagery stored in the document-imagery repository 21. Specifically, in the case where the user first specifies a piece of document imagery, the imagery selector 25 refers to the image-component repository 23, acquires the information used to link to a page containing the image component in the piece of document imagery, and selects an image of the page of the piece of document imagery based on this information. Further, in the case where the user first specifies a folder, the imagery selector 25 refers to the image-component repository 23, acquires the information used to link to a piece of document imagery containing the image component, and selects the piece of document imagery based on this information.

Next, the display-information creator 26 creates display information for presenting the piece of document imagery selected in step S262 (step S263).

Thereafter, the transmitter 27 transmits the display information created in step S263 to the client terminal 30 (step S264). In this way, the client terminal 30 presents the piece of document imagery selected in step S262.

### Processor

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

### Program

Processing performed by the document-imagery server 10 according to the present exemplary embodiment is, for example, provided as a program such as application software.

Specifically, a program achieving the present exemplary embodiment is regarded as a program causing a computer to execute a process including accepting specification of at least one piece of document data and specification of a specific attribute of chart data and presenting chart data that is contained in the at least one piece of document data and that has the specific attribute.

A program achieving the present exemplary embodiment may be provided by transmission via a communication unit or in a stored form in a recording medium, such as a compact-disc ROM (CD-ROM).

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

1. An information processing apparatus comprising:
a processor configured to:
accept specification of at least one piece of document data and specification of a specific attribute of chart data;
present the chart data that is contained in the at least one piece of document data and that has an attribute matched the specific attribute on a screen by using a discriminator, wherein the discriminator is trained by using training document data and ground truth data, and
wherein the chart data is formed by a plurality of pieces of chart data; and
present the plurality of pieces of chart data contained in the at least one piece of document data in a folder represented by a folder icon in response to the folder icon being specified, wherein the plurality of pieces of chart data are presented based on an attribute thereof, and
wherein the specific attribute is a type of chart, and the attribute of the plurality of pieces of chart data is an appearance of chart.

2. The information processing apparatus according to claim 1,
wherein the processor is configured to identify the specific attribute and the chart data, the specific attribute and the chart data having been extracted in advance from the at least one piece of document data.

3. The information processing apparatus according to claim 1,
wherein the processor is configured to further present at least one attribute of the plurality of pieces of chart data, the at least one attribute being different from the specific attribute.

4. The information processing apparatus according to claim 3,
wherein the processor is configured to identify the at least one attribute that has been extracted in advance from the at least one piece of document data.

5. The information processing apparatus according to claim 3,
wherein the processor is configured to:
accept specification of an attribute out of the at least one attribute, the attribute being different from the specific attribute; and
present at least one piece of chart data having the attribute different from the specific attribute, the at least one piece of chart data being obtained by narrowing down the plurality of pieces of chart data.

6. The information processing apparatus according to claim 5,
wherein the processor is configured to:
accept specification of a specific piece of chart data out of the at least one piece of chart data; and
present a piece of document data containing the specific piece of chart data or a portion of a piece of document data, the portion containing the specific piece of chart data, out of the at least one piece of document data.

7. (canceled)

8. The information processing apparatus according to claim 1,
wherein the processor is configured to present the plurality of pieces of chart data in different regions in accordance with the attribute different from the specific attribute of the plurality of pieces of chart data.

9. The information processing apparatus according to claim 1,
wherein the processor is configured to present the plurality of pieces of chart data arranged in an order in accordance with the attribute different from the specific attribute of the plurality of pieces of chart data.

10. The information processing apparatus according to claim 1,
wherein the processor is configured to:
accept specification of a specific piece of chart data out of the plurality of pieces of chart data; and
present a piece of document data containing the specific piece of chart data or a portion of a piece of document data, the portion containing the specific piece of chart data, out of the at least one piece of document data.

11. A non-transitory computer readable medium storing a program causing a computer to execute a process, the process comprising:
accepting specification of at least one piece of document data and specification of a specific attribute of chart data;
presenting the chart data that is contained in the at least one piece of document data and that has an attribute matched the specific attribute on a screen by using a discriminator, wherein the discriminator is trained by using training document data and ground truth data, and wherein the chart data is formed by a plurality of pieces of chart data; and
presenting the plurality of pieces of chart data contained in the at least one piece of document data in a folder represented by a folder icon in response to the folder icon being specified, wherein the plurality of pieces of chart data are presented based on an attribute thereof, and wherein the specific attribute is a type of chart, and the attribute of the plurality of pieces of chart data is an appearance of chart.

12. An information processing method comprising:
accepting specification of at least one piece of document data and specification of a specific attribute of chart data;
presenting the chart data that is contained in the at least one piece of document data and that has an attribute matched the specific attribute on a screen by using a discriminator, wherein the discriminator is trained by using training document data and ground truth data, and wherein the chart data is formed by a plurality of pieces of chart data; and
presenting the plurality of pieces of chart data contained in the at least one piece of document data in a folder represented by a folder icon in response to the folder icon being specified, wherein the plurality of pieces of chart data are presented based on an attribute thereof, and wherein the specific attribute is a type of chart, and the attribute of the plurality of pieces of chart data is an appearance of chart.
